(19) United States
(12) Patent Application Publication
(10) Pub. No.: US 2019/0108560 A1
(43) Pub. Date: Apr. 11, 2019

(54) Method for automatically financing bills

(71) Applicants: Eckehard STOLZ, Bregenz (AT); Matthew HATTON, Warwick (GB)

(72) Inventors: Eckehard STOLZ, Bregenz (AT); Matthew HATTON, Warwick (GB)

(21) Appl. No.: 16/093,876

(22) PCT Filed: Apr. 3, 2017
(86) PCT No.: PCT/EP2017/057901

§ 371 Date: Oct. 15, 2018

(30) Foreign Application Priority Data
Apr. 15, 2016 (DE) 10 2016 107 072.6

(51) Int. Cl. G06Q 30/04; G06F 16/22; G06Q 30/02

(52) U.S. Cl. CPC G06Q 30/04; G06Q 30/0215; G06F 16/22

(57) ABSTRACT

The invention relates to a computer implemented method for automatically financing bills between a buyer and a seller by means of a financier using a management platform. Financing offers and buyer/seller target values for business performance indicators are collected and stored. A bill with billing information is received from a buyer and/or a seller. Potential financiers for the bill are identified by comparing the billing information with the financing offers of the financier and the stored target values for the business performance indicators of the seller and/or the buyer stored. If more than one potential financier is identified, the best financier is determined by identifying which financing offer best corresponds to the target values of the seller and/or buyer. Without input from a user, the system automatically contracts the financing of the bill, transmits payment from the financier, and settles accounts between the buyer, the seller and the financier.

The invention relates to a method for automatically financing bills according to claim 1, and to a corresponding management platform according to claim 16 and a corresponding computer program product according to claim 17.

In the provision of a service or delivery of goods to a buyer by a seller, a bill is usually sent by the seller to the buyer. The bill usually includes defined periods of time within which a bill must be settled. From the time that the bill is issued, however, conflicting interests exist on the part of the buyer and the seller. The buyer will usually try to pay a bill as late as possible, to keep the relevant capital available for other expenditure for as long as possible. The seller, on the other hand, is interested in the earliest possible settlement of a bill, because he/she, for their part, would like to have the corresponding financial resources available to enact further expenditure. The seller often attempts to create an incentive for a speedy payment of bills by offering a price reduction if the bill is paid within a shorter period of time. This is also known under the term “discount”.

The possible discounts arising from this often remain unused, however. Either because a buyer has no interest in a price discount for business reasons, since a delay in the payment of the bill is more profitable, or because the relevant financial administration of a buyer is not in a position to process a bill quickly enough to be able to take advantage of a discount offered. A solution sometimes used in this case consists in obtaining the financing of the bill by a financier. In this case financing offers will usually be taken up, which require a certain flat rate of interest for a specific amount. However, these offers are generally not tailored to the specific business economic situation of the buyer and seller, but instead they tend to involve fixed, predefined financing models. The use of a financing arrangement by the buyer and/or seller often involves high accountancy effort, which makes, in particular, the financing of minor bill amounts uneconomic. There is as yet no satisfactory model which serves both the interests of the buyer and the interests of the seller.

The object of the present application is therefore to overcome the disadvantages of the prior art mentioned above and to create an improved, automated method for processing the financing of bills.

The main features of the invention are specified in claim 1, as well as claims 16 and 17. Configurations of the invention are the subject matter of claims 2 to 15.

A first aspect of the present invention relates to a computer-implemented method for automatically financing bills between a buyer and a seller by means of at least one financier using a management platform, wherein the management platform comprises at least one database and at least one analysis unit. The at least one database contains stored flat-rate financing offers for financing bills for the at least one financier, and target values for business performance indicators of at least the seller and/or the buyer. The method then comprises the steps described below.

Firstly, the management platform receives a bill from the buyer and/or the seller, wherein the bill contains at least one piece of billing information. The analysis unit then ascertains at least one potential financier for the bill received, by comparing the at least one piece of billing information of the bill with the flat-rate financing offers of the at least one financier and the target values for the business performance indicators of the seller and/or the buyer stored in the database of the management platform.

If as a result at least two potential financiers are ascertained, then by means of the analysis unit the best financier is then ascertained whose flat-rate financing offer best corresponds to the target values for the business performance indicators of the seller and/or buyer. The financing of the bill by the financier thus ascertained is then automatically transacted by the intermediary platform, and the bill amount is transferred to the seller by the financier. A subsequent payment from the buyer to the seller in order to settle the bill is then redirected to the financier by means of the management platform in the event of a successful financing of the bill by means of a financier.

The “management platform” can be, for example, a server computer system on which a corresponding program is installed, which can carry out the method described. In this case, the “database” can be a data store installed in the computer system or connected to the computer system, such as a hard drive. The “analysis unit” in this case can be formed, for example, by one or more single-core or multi-core processors. In this embodiment, the management platform also preferably has at least one communication interface via which the management platform can communicate with other computer systems or a network of computer systems. For example, this network may be the internet. The management platform can also be implemented partially or completely in a virtual form, however, in the form of cloud computing in a distributed computing system.

The communication interface is preferably used for communication between the management platform and the computer systems, each of which are entrusted with the creation and administration of bills on the part of both the buyer and the seller. The terms “buyer” and “seller” here are to be understood in their common meanings. For example, the seller can be the manufacturer and/or distribution department of a certain commercial product, while the buyer is the corresponding user of the product. Buyer and seller are in a position to send bills to the management platform using their respective computer systems. In addition, buyer and seller can store target values for their business performance indicators in the database of the management platform.

The target values for business performance indicators are, for example, terms of payment of bills, a desired rate of return on capital, a liquidity to be achieved, or similar figures. For example, a liquidity to be achieved can also be associated with a date by which the said liquidity should be available. In particular, a seller may also define the extent to which, in the event of outstanding bill amounts, a seller is prepared to grant a price reduction (discount) for an early settlement of the bill. This can involve defining, for example, that for a payment within 1 week a 5% discount will be granted, within 2 weeks one of 3%, and from two weeks the full bill amount must be paid.

Although the description above mostly refers to a buyer and a seller, the target values of a plurality of buyers and sellers can be stored in the management platform. The target values stored in the database for business performance indicators are not necessarily fixed values. Rather, a buyer and/or a seller can dynamically modify the defined target values at any time to suit the business situation of the buyer/seller. For example, it can be provided that certain key indicators must be optimized before the end of each quarter. After the end of the quarter, on the other hand, other indicators can become more relevant, so that the stored target values are adjusted. In addition, it may also be the case that a buyer orders a large supply and decides at short notice that he/she would like to use the high discount offered by their supplier. In addition to manual input or modification of target values it could also be provided that buyer and seller program a set of dynamics into the stored target values. For example, it can be defined such that a stored target value should be raised by a certain amount over a certain time period. In addition, different target values can also be defined for specific time periods. Thus, buyers and sellers can stipulate, for example, different target values for the pre-Christmas season than for the rest of the year.

In addition to buyers and sellers, one or more financiers are registered on the management platform. The term “financier” can be understood as a financial sponsor, embodied, for example, by a bank, a company, or even a private individual. The financiers deposit flat-rate financing offers in the database of the management platform. For example, such a flat-rate financing offer can include the fact that a certain financier is prepared to settle a certain number of bills up to a specific bill amount for a short period as a substitute for the actual debtor (the buyer). A financing offer can in this case include a plurality of boundary conditions for a financing arrangement, which will be discussed later. A financing offer is associated with an authorization of the management platform, upon the detection of a bill which can be covered by the financing offer, to automatically transact a financing of the bill by the financier.

If a bill is sent to the management platform by the seller and/or buyer, the bill is first analyzed by the analysis unit with regard to its content. Usually, a bill will include as bill information at least a definition of a buyer and a seller, as well as an amount of money to be paid by the buyer to the seller, and the standard payment terms (payment target, any discount offered). The analysis unit is then further designed to compare the billing information thus determined with at least the target values for the business performance indicators of the seller and the flat-rate financing terms offered by the financiers stored in the database, to determine one or more potential financiers for the bill. A short example of this process is described below.

The bill identifies an amount payable of €10,000. In addition, in their target values the seller has specified that he/she is prepared to grant a discount of 3% of the bill amount for payment of a bill within 2 weeks. Three other financing offers are also stored in the database. A first offer states that bills up to an amount of €8,000 will be financed for a yield of at least 2%. A second offer describes that bills up to an amount of €20,000 and a yield of at least 4% will be financed, while a third financing offer finances bills of up to €15,000 if the yield is at least 2%.

In the comparison of the bill information with the financing offers and the target values of the seller, the first financing offer is eliminated since the amount of the bill exceeds the financing limit. The second financing offer is also eliminated, because although the financial limit is sufficient, the financier nevertheless requires a higher minimum yield than the seller is prepared to grant. Only the third financing offer meets the requirements which are defined by the bill information and the target values of the buyer.

The bill management platform then automatically transacts financing of the bill by the financier who deposited the third financing offer in the database. Then, the bill amount due is paid promptly to the seller by the financier, minus the discount of 2% of the bill amount in this case. In doing so it should be ensured that the maximum possible discount value granted by the seller is not used, but rather the value that is offered by a financier.

The bill is thus settled from the point of view of the seller. In the further course of events the actual buyer instructs the payment of the bill amount due via the management platform, then the management platform registers, for example based on the bill number, that it is a financed bill. The payment made by the buyer is then redirected to the financier who has performed the financing of the bill.

If in the example described above the database contained a fourth financing offer, which describes, for example, a financing arrangement for bills up to €12,000 for a yield of at least 1%, both the financier of the third financing offer as well as the financier of the fourth financing offer would have qualified as potential financiers. However, since the fourth financing offer most closely matches the target values of the seller, because it means the lowest loss, in this case the management platform would conclude the financing contract with the financier of the fourth financing offer. Depending on which target values are defined by a seller and which financing offers are stored in the database, it can also be provided in accordance with the invention that a single bill is financed by a plurality of financiers. The piecewise settlement of the bill by the plurality of financiers would then be coordinated by the management platform.

The method according to the invention in this case has essentially two advantages. On the one hand, the seller has the outstanding funds at their disposal within a short period of time, so that further investments can be made by the seller. At the same time, a financier can benefit from discounts granted by the seller in the event of early payment, for example by investing excess capital to settle the outstanding bill. In doing so, because of the discount granted the financier is in general obliged to invest less money in the settlement of the bill than he/she will later recoup on settlement of the bill by the buyer. Effectively this results in a gain for the financier. The management platform is also designed to locate from the available financing offers that financing offer for a seller which best suits the target values for his/her business performance indicators. This does not necessarily have to be the financing offer which provides the lowest discount. Instead, a financing offer can also be suitable even if its requested discount is not the lowest compared with other financing offers, but its financing nevertheless guarantees a certain liquidity at a particular time. The method described above also proceeds fully automatically by means of a suitably programmed management platform, so that no additional accounting effort arises.

Another potential advantage of the method is readily apparent from another example. For example, if a bill has been received on the management platform, which defines standard discount terms for a particular bill amount in the bill information, such as 2% discount for payment within 14 days and full payment of the bill being due after 30 days. It is entirely possible in this case that the seller has not defined any target values for business performance indicators in the database of the management platform, but the buyer has specified that he/she wants to delay payment for as long as possible. In this case, a suitable financing offer may be, for example, that a financier makes the payment of the bill within the period of 14 days to claim the offered discount, but the settlement of the financing by the buyer need not be made for 90 days. In effect, the financing therefore primarily serves the requirements of the buyer for an extension of the payment date, so that the buyer can improve his/her working capital. Thus, using the method according to the invention, by means of an automated financing arrangement the business performance indicators of a buyer can be improved.

It should be noted here that not only is the financing of bills processed using the management platform, but also that bills for which no suitable financing offer can be found are also processed using the management platform. With the method it is possible, for example when a bill amount is paid to the seller, for additional payment information to be added to the payment instruction by the buyer, which indicates, for example, if a discount is being claimed by the buyer or whether a bill amount is being settled with existing credits. In this way, the posting of a payment is easier on the part of the seller and can ideally be implemented in a fully automated way. The management platform can also be designed to read out the payment information before forwarding a payment to the seller, and to use the information thus obtained, for example, for an evaluation of subsequent bills or to create a billing history.

In addition to a pure bill amount, according to one embodiment a billing information can have a piece of information which identifies the bill itself, the context of the bill and/or a history of the bill. A piece of information which identifies the bill itself is, for example, the buyer, the seller, the payable bill amount, payment terms, the goods to be paid for by the bill or a status of the bill, for example, whether the bill has been adjusted by the buyer or seller, whether the bill has been approved or rejected, or something similar. A piece of information which describes the context of the bill is, for example, the country in which the buyer or seller has their place of business, the ordering department of the purchaser, or something similar. Examples of information about the history, for example, are the number of similar bills in the past, the number of similar bills from other sellers or the proportion of bills of a buyer or seller which in the past have given rise to problems, for example by means of payment defaults, complaints or late payment.

According to a preferred embodiment this additional information can be used by the analysis unit to determine a risk value for a received bill from the billing information, wherein the risk value specifies the probability that a bill will be paid by a buyer on time. If, for example, the billing information reveals that a bill was approved by the buyer and the seller and that there has been a plurality of bills between the buyer and the seller in the past, all of which were processed without any problems, then the bill can be assigned a low risk value. On the other hand, if the bill information reveals that a buyer has not yet accepted a bill, or that there were problems with this buyer in the past, the bill is assigned a high risk value by the evaluation unit. The risk values thus identified for bills can in turn be used by financiers to assess whether or to what extent a financing arrangement is liable to a risk of default. For example, a financier can decide that he/she will only finance bills with a high risk if the expected yield is correspondingly high.

According to embodiments, in the flat-rate financing offers of a financier an upper limit for risk values of bills can be defined, wherein for bills whose risk value is above the defined upper limit the corresponding financier is not ascertained as a potential financier and/or the bill is referred to the financier with the second-best flat-rate financing offer. The definition of a maximum permissible level of risk for a financing arrangement therefore gives a financier an additional tool with which he/she can define the financing arrangements provided by him/her in a more fine-grained way. For example, a financier can link, for example, an upper limit for a risk value with a yield to be achieved. For example, it can be defined such that a financier may only finance a high-risk bill if the achievable yield is high enough to justify the risk of failure. A financier can also deposit multiple flat-rate financing offers in the management platform. For example, a financier can deposit two flat-rate financing offers, one with a low required interest rate but a restrictive limit for the risk to be accepted, and one with higher potential risk but with higher interest in return. The automation of the assignment of flat-rate financing offers to bills can thus enable a financier to grow their potential business.

Overall, according to embodiments, in a flat-rate financing offer at least one of the following is defined: a financial limit for a financing arrangement, a number of bills to be financed, nature and/or risk profile of the bills to be financed, at least one buyer to be financed, at least one seller to be financed, at least one pair of buyer and seller to be financed, and/or a minimum profit to be achieved. For this purpose, to enable a financier to define a financing offer, the management platform can present an input screen, for example, in which he/she can input the corresponding values for a financial limit, a number of bills, a limit value for the risk value or a minimum level of profit. In addition, for example, a checklist can also be displayed in which a financier can select a buyer and seller, whose bills he/she is willing to finance. In this case, each buyer and seller can in turn be provided with an information field in which a financier is displayed figures relating to the corresponding buyer or seller, such as their payment reliability or credit rating.

The degree of automation of the method described above can be further increased according to a further embodiment, by bills being automatically sent from a billing management system of a buyer and/or seller to the management platform after the bill is issued. For this purpose, the IT systems of the buyer and seller are preferably connected to the management platform in such a way that issued bills are uploaded automatically via a network, such as the internet, to the management platform. In this way, on the one hand the loads on the bill management systems of the buyer and/or seller are reduced, while at the same time bills issued by a seller can be quickly managed in the management platform for financing. Thus, ideally a bill can be settled by a financier in an even shorter time compared to the seller. It is also entirely possible to provide that not all bills issued by a seller or received by a buyer are uploaded to the management platform, but that it can be specified on an individual basis whether a bill is intended for financing or not, for example via an appropriate control field, at the time of issuing the bill.

According to a further embodiment it is also provided that before transacting the financing of the bill by the financier, the management platform requests confirmation from the buyer and/or the seller. The financing of the bill by the financier in this case is only transacted by the management platform once all of the requested confirmations are issued. It is entirely possible in this case that the request for a confirmation is only provided for certain bills. For example, at the time of the issuing a bill a seller can specify that in the event of a possible financing he/she would first like to be informed regarding the proposed financing, in order to be able to decide, for example due to short-term circumstances, whether a financing and thus a price reduction is worthwhile, or whether the early settlement of the bill associated with a price discount currently offers no economic advantage to the seller. It can also be specified by a seller in the target values for business performance indicators that, in the case of a financing offer which does not exactly correspond to the target values but very closely matches the target values, in the individual case a confirmation of the financing is to be obtained. For example, a seller can specify that he/she is prepared to grant a discount of 3% in the event of a payment within 2 weeks. A financing quote can then specify, for example, that the payment is made within a week, but a discount of 3.2% is requested in return. Since this involves only a small discrepancy with respect to the target values of the seller and an additional advantage can be gained from the early payment, a consultation with the seller as to whether the financing is confirmed may be advantageous for the seller.

On the payment of a bill, information is usually attached to the corresponding remittance, which indicates the bill, identified by a bill number, to which the remittance relates. In the case of financing of a bill, however, a receipt of payment from a financier can result in two special circumstances for the accounting system of the seller. Firstly, the payment is not made by the buyer designated in the bill, and secondly, as a result of the financing the bill amount is reduced compared to the amount designated in the bill. This can lead to the bill being deemed “not fully paid” by the accounts system of the seller, despite receipt of payment. According to one embodiment, however, this can be avoided by a first piece of payment information being attached to the remittance of the bill amount from the financier to the seller by the management platform, wherein the first piece of payment information indicates at least that the payment is made as a result of a financing arrangement, the bill on which the payment is based, and the adjustment of the bill amount which is made due to the financing. In this way, a unique assignment of the remittance can be made to the appropriate bill by the seller, while at the same time the reasons for the difference in the remitted amount and the remitting party are made clear and therefore an automated accounting entry of the special discount is possible.

According to a further embodiment it is also provided that in the event of financing of a bill by a financier, the management platform generates a financing transaction associated with the financed bill and the financier, which the platform stores in the database. The financiers registered on the management platform will then have access to the financing entries assigned to them, which are stored in the database. A financial entry can be understood essentially as a confirmation or proof that a financier has undertaken a financing arrangement and given this fact, which bill is being financed and subject to which conditions. In this way, the financier can make a clear assignment in his/her accounts system of entries from his/her business accounts to sellers.

In addition, according to a further embodiment the financing entries can be used to ensure that a settlement of a financing arrangement by a buyer is traceable for the financier. To this end it is provided that, when redirecting the payment from a buyer to the financier the management platform attaches a second piece of payment information to the corresponding payment transfer, wherein the second piece of payment information designates the financing transaction which is associated with the financed bill on which the payment is based. In this way, on receipt of a payment the financier can clearly trace which amount of money received belongs to which financing arrangement. The clear attributability of payment receipts then allows a fully automatic processing of the financing arrangements of a financier through their accounting system. In this manner, further administrative costs on the part of the financier can be effectively avoided, which in turn allows a financier to offer more favorable financing arrangements.

The automation of the method discussed previously can be further improved according to a further embodiment, by the fact that the remittance of the bill amount from the financier to the seller is instructed by the management platform. To this end it can be provided, for example, that a financier, when setting a flat-rate financing offer in the management platform, at the same time grants permission to the management platform to enact funds transfers in their name within the parameters defined in the financing offer. A separate account assigned to the financing platform may be opened for a financier for this purpose, for example. In this case, at the time of depositing a flat-rate financing offer the financier should credit the appropriate account with an amount of money corresponding to the financing offer and empower the management platform to enact transactions from this account in his/her name. In this way, the procedure from the moment at which a bill is received at the management platform would be further automated, so that financing arrangements can be carried out very quickly and cost-effectively. This can be advantageous both for the financier, due to higher achievable discounts, as well as for the seller, due to earlier payment receipts.

In addition, according to one embodiment it can be provided that the financier is informed of changes in the billing information items after the forwarding of the bill to the financier. For example, it may occur that a bill is financed by a financier, although the bill has not yet been confirmed by the buyer. In this case, the bill has an inherently higher risk of not being paid by the purchaser. If in fact it does occur that a financed bill is either not paid or only partially paid by a buyer, for example because a delivered product is incomplete or damaged, or because the buyer has become insolvent, the financier is automatically informed about this circumstance by the distribution platform. This gives the financier the option to modify or completely withdraw existing financing offers not yet claimed for a financing arrangement. For example, a financier thus has the possibility of excluding a buyer from the parameters of its flat-rate financing offers who has previously failed to pay a bill financed by the financier. Conversely, in the event of a subsequent confirmation of an as yet unconfirmed bill by a buyer, a financier can reduce the collateral provided for covering the risk of default on the financing arrangement, since after a reciprocal confirmation of a bill the risk of default on a bill decreases.

According to a further embodiment, the buyer can change the bill information of the bill and/or add additional bill information to the bill. For example, in this case it can be provided that a buyer can add a comment to a bill, for example if he/she does not agree with some information in the bill or questions some billing information. In addition, for example, in the event of a faulty or incomplete product delivery to the buyer, the buyer can send evidence in the form of images or documents relating to the bill to the management platform, so that it becomes clear to a seller as to why a buyer is questioning or contesting a bill. Similarly, the seller can also be allowed the opportunity to forward additional bill information about a bill to the management platform, or to comment on billing information added retrospectively by the buyer.

According to a further embodiment, this additional billing information, which is stored in the management platform either by sending of the bills by the buyer or by addition of further information from the buyer can be supplemented by further payment information upon the remittance of the bill amount by the financier (in the case of financed bills) or by the buyer (in the case of non-financed bills) to the seller, wherein a further piece of payment information at least indicates that the payment shows deviations from the expected payment amount as a result of adjustments on the part of the buyer. In this way, a unique assignment of the remittance to the corresponding bill can be made by the seller, while at the same time the reasons for the difference in the remitted amount are made clear and an automated accounting entry of the special discount is therefore possible. For example, the buyer might have complained about an incomplete delivery and agreed a special deduction with a staff member of the seller.

According to a further embodiment the management platform stores a history of the bills processed on the management platform in the database. From the history, the stored flat-rate financing offers and the stored target values for business performance indicators of buyers and/or sellers, the analysis unit then determines a risk profile for bills with similar billing information for future financing arrangements and provides these to the at least one financier. This enables the financier to make a further assessment of the risk of default on a bill.

So far, the method has been described in a way that assigns the buyers and financiers to different persons or companies. According to one embodiment, however, it is also provided that at least one of the financiers is a buyer. Thus, a buyer can also have currently surplus or unneeded financial resources, which he/she would prefer to deploy profitably as part of a financing arrangement. To this end a buyer can act as a financier for bills in which he/she is initially not participating as a buyer. In this way, a buyer can provide support, for example, to companies which in turn assist him/her. For example, a buyer can finance bills of a company which also acts as a supplier to the buyer, in order to increase its performance or productivity.

A further aspect of the invention relates to a management platform for automatically financing bills between a buyer and a seller by means of at least one financier, wherein the management platform has at least one database and at least one analysis unit, wherein flat-rate financing offers for financing bills for the at least one financier and target values for business performance indicators of at least the seller and/or the buyer are stored in the at least one database. The management platform in this case is designed:
to receive a bill from the buyer and/or the seller, wherein the bill contains at least one piece of billing information,
to ascertain by means of the analysis unit at least one potential financier for the bill by comparing the at least one piece of billing information of the bill with the flat-rate financing offers of the at least one financier and the target values for the business performance indicators of the seller and/or buyer stored in the database of the management platform,
if at least two potential financiers have been ascertained, to ascertain by means of the analysis unit the best financier whose flat-rate financing offer best corresponds to the target values for the business performance indicators of the seller and/or buyer,
to automatically transact the financing of the bill by the financier ascertained, so that the bill amount will be paid to the seller by the financier, and
to redirect a subsequent payment from the buyer to the seller in order to settle the bill in the event of a successful financing of the bill by means of a financier.

It goes without saying that the embodiments of the method described above or below are inherently transferable by analogy to the management platform and are therefore part of the claimed invention.

A further aspect of the invention relates to a computer program product, which when executed on a computer system causes the computer system to carry out the method described above or below.

Further features, details and advantages of the invention result from the wording of the claims, as well as from the following description of embodiments on the basis of the drawings. Shown is:

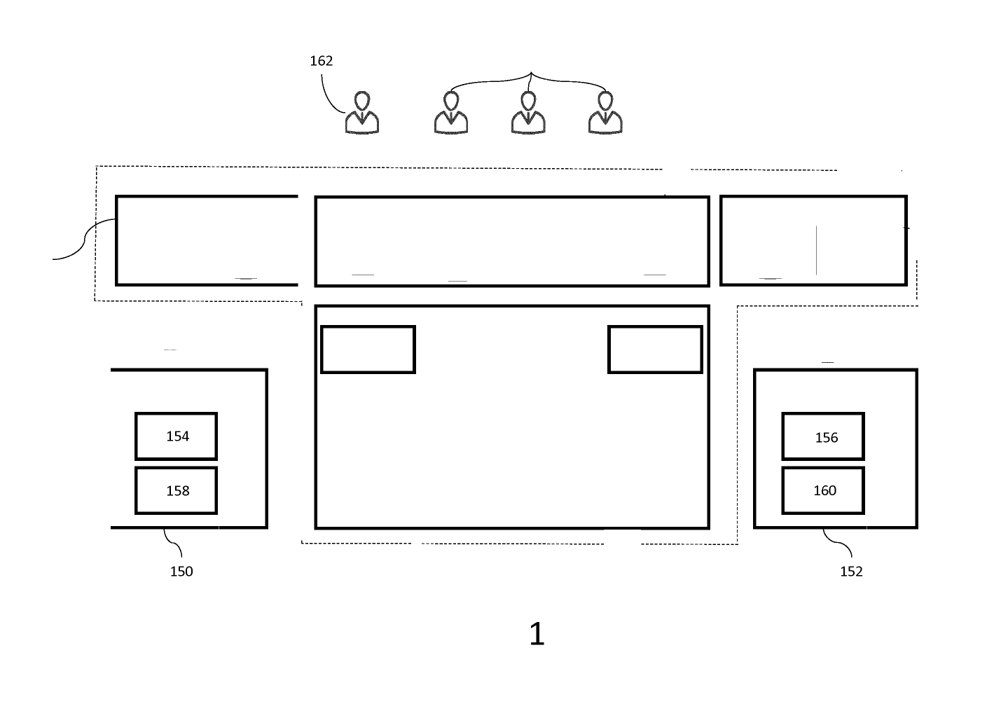

FIG. 1 a schematic view of the structure of one embodiment of a management platform.

FIG. 1 shows a schematic illustration of an embodiment of a management platform 100. The management platform 100 here is composed essentially of four partial platforms 102, 104, 106 and 108.

A first partial platform is the platform for the payment of bills 102. The platform 102 essentially comprises four databases 110, 112, 114 and 116, as well as six program modules 118 to 128. Even if the databases 110 to 116 are shown in FIG. 1 as separate databases, it is quite possible in accordance with the invention to provide that the databases 110 to 116 are merely sub-regions of a common mass storage device of a computer system used. Similarly, the program modules 118 through 128 can also be implemented by different processor modules of a computer system or by a common processor module.

The databases of the platform 102 comprise a database 110 which is designed for storing unconfirmed bills, and a database 112 for storing confirmed bills. In addition, bills which are financed by a financier 140 are stored in the database 114, while all bills which have been processed using the management platform 100 are stored in the database 116. These can be both bills which were financed by a financier 140 and the financing of which is completed, and bills which were not settled by means of a financing arrangement, but directly between the buyer 136 and seller 138. By the collection of both the financed bills and the non-financed bills, an improved risk assessment for current and future bills can be achieved. Thus, for example, from the totality of all bills in which a particular buyer 136 was involved, regardless of whether the bill was settled using a financing arrangement, an accurate profile of the reliability of the buyer can be created for a risk assessment of further bills.

The program modules of the platform 102 are a portal 118 for the confirmation of financing arrangements and for uploading bills to the platform 100 by a buyer 136, a module for ascertaining suitable flat-rate financing offers 120, a module for the management of financing arrangements 122, a portal 124 for the confirmation of financing arrangements and for uploading bills to the platform 100 by a seller 138, a module for the management of the payment of bills 126 and a module for management of the payment of financing arrangements 128.

The platform 104 serves as an interface for financiers 140 with the management platform 100 and has three databases 130 to 134 as well as a program module 136. In the database 130 a number of possible financing offers is stored, while in the database 132 those financing offers for which a financier has agreed to enter into are stored. Finally, the database 134 contains financing transactions which are used as proof of a completed financing of a bill by a financier 140. The program module 136 also acts as a user interface for financiers 140, via which financiers 140 can enter into flat-rate financing offers, for example, or can view financing arrangements they have undertaken.

The platform 106 is used for the management of target values for business performance indicators of sellers and has a database 142 for storing corresponding seller profiles of the target values for business performance indicators, as well as a program module 144 which acts as a user interface for sellers, via which sellers can view and change the information stored in the database 142. In an analogous way the platform 108 is used for the management of target values for business performance indicators of buyers, and for this purpose has a database 148 for storing corresponding buyer profiles of the target values for business performance indicators, as well as a program module 146 which acts as a user interface for buyers, via which buyers can view and change the information stored in the database 142.

The user interfaces implemented by the program modules 144 and 146 are also used to indicate to a buyer 136 or a seller 138 the effect of a claimed financing arrangement on the target values of the business performance indicators stored in the databases 142 and 148 respectively. In this way, the buyers 136 and sellers 138 registered on the management platform 100 are offered an interface in which they can track changes in their performance indicators in real-time on the basis of financing arrangements, and by means of which they can quickly adjust their target values if necessary to the changes shown in the performance indicators. As a result, the target values for business performance indicators can be very rapidly fine-tuned by buyers 136 or sellers 138.

The management platform 100 assembled from the partial platforms 102, 104, 106 and 108 can be implemented either on a single computer system or on a decentralized, distributed computer system. In this regard, the computer system preferably has an interface via which the management platform 100 is connected to a network, such as the internet.

Finally, FIG. 1 also shows, in each case as examples, system 150 for the planning and control of the corporate resources of the buyer 136, and an analogous system 152 for the planning and control of the corporate resources of the seller 138. The systems 150 and 152 each have a program module 154 or 156 for managing bills, as well as a program module 158 and 160 for financing arrangements and payments of bills. The systems 150 and 152 here are connected to the platform 100 via a network, not shown, such as the internet.

As has been stated previously, a plurality of financing options is stored in the database 130, which a financier 140 can enter into. A financing option in this case can be a financing of a credit line for a buyer, a financing of a set of bills between a specific buyer and a specific seller, the financing of a set of bills from a specific buyer with specific boundary conditions (for example, the financing of bills with a bill amount of between €1,000 and €10,000) or similar configurations. These financing options are associated with risk information which is based on the history of bills, of the financing arrangements or other information, and which enables a financier 140 to make a risk assessment in the event that he/she decides to enter into such a financing option.

If a financier 140 decides to enter into such a financing option, the corresponding financing option is transferred as a flat-rate financing offer of the financier into the database 132, in which flat-rate financing offers entered into are stored. In the moment in which a financier 140 makes such a flat-rate financing offer, he/she declares, for example, in a contractually fixed manner, that he/she accepts any request for financing which satisfies the parameters defined in the flat-rate financing offer. In the database 132 one or more flat-rate financing offers from one or more financiers 140 are then stored with the respective financing conditions.

For example, two financiers 140 have set up a credit line for a particular buyer A. A first financier is prepared to finance bills, for example, at a yield of 0.7% and a financing limit of €1 million for a maximum bill amount per single bill of €10,000, while a second financier 140 requires a yield of 0.75%, but is prepared to pay bills with a respective bill amount of up to €50,000. These values are entered via the user interface 136 of the platform 104.

For example, both companies, such as financial institutions, and private individuals can act as financiers 140. It is also possible for a buyer 162 to act as a financier, for example if currently unused funds are available.

Buyers 136 and sellers 138 can, for their part, again store target values for business performance indicators in the databases 148 and 142 of the management platform 100 via the respective platforms 108 and 106 by means of the appropriate user interfaces 146 and 144. For example, in these databases it is possible to define which discounts can be granted on bills in the event of early payment, which payment targets are to be achieved, which funds must be available when, and the like.

In addition, buyers 136 and sellers 138 can send bills via their respective accounting systems 150 and 152 by means of the appropriate program modules 154 and 156 via the appropriate portals 118 and 124 to the platform 102, wherein the bills are first stored in the database 110 for unconfirmed bills until they have been confirmed by the buyer and seller. However, as soon as an incoming bill has been confirmed by a buyer 136, the bill can be transferred into the database 112 for confirmed or approved bills. In this case, the incoming bills are assessed in relation to their inherent risk of default. For example, a bill that has not yet been confirmed by the buyer is assessed as having a higher risk than a bill which has already been confirmed by the buyer. In addition, other factors such as experience data on the payment behavior of a buyer 136 with respect to a seller 138 can be fed into the assessment of a bill. The systems 150 and 152 can in this case be designed to send issued bills to the management platform 100 automatically.

If bills are stored in the databases 110 and 112, the program module 120 is designed to continuously compare the deposited bills and the billing information contained therein with the flat-rate financing offers stored in the database 132. In addition, suitable financing offers are compared with the target values stored in the databases 148 and 142. If in doing so one or more financing offers is found for a given bill, which would improve the respective business performance indicators according to the target values, this financing offer is placed in temporary storage as a potential financing offer. From the potential financing offers thus found, that financing offer is then sought which most closely corresponds to the target values defined by the seller 136 and/or the buyer 138.

The buyer 136 and seller 138 then have the option to also define in their respective target values that, in the event of a financing offer which matches a bill, the financing is automatically taken up. In this case, the financing can be transacted automatically by the management platform 100 and transferred to the module 122 for the management of financing arrangements. In the case that no automatic confirmation of a financing arrangement is provided for by the buyer 136 or seller 138 specified in the bill to be financed, the management platform 100 can also alternatively request a confirmation from the buyer 136 and/or the seller 138 as to whether a financing offer is to be taken up. In this case, via the appropriate portal 118 or 124 the buyer 136 and/or seller 138 can either agree to the financing, or reject the financing.

After the financing of a bill has been transacted, the program module 122 creates a corresponding data object with the bill and the selected financing offer in the database 114. In addition, accepted financing offers and/or the financing arrangements resulting therefrom are also displayed in the corresponding user interfaces 136 of the financiers 140. In this way, the registered financiers 140 receive an overview of current financing arrangements, as well as the associated data on the yields achieved, the status of the bill, the risk of the bill, the achieved profit, etc. Financing transactions relating to the financing are also stored in the database 134, wherein the financiers 140 can access their respective financing transactions, for example to allow them to enter the current financing arrangements in their respective accounting systems.

As soon as the due date of a financed bill is reached, the management platform 100 or the program module 128 triggers the payment of the bill by the financier 140, for example in the form of a remittance of the bill amount minus the price discount granted by the seller. This can be effected, for example, using a separate account of a financier, for which the management platform has been granted executive authority. In this case, the program module 128 can also check, for example prior to the funds transfer, whether the account has sufficient funds to make the payment and, if necessary, to prompt a financier 140 to provide sufficient credit in the account. In doing so, the program module 128 ensures that the bill is paid by the financier on time.

Further billing information can be added by the program module 128 to the remittance of the bill amount to the seller 138. This can include specifying, for example, the bill to which the payment relates, whether or which financing arrangement the payment is based on, and what price discount has been set as part of the financing arrangement. This information can be used by the program module 160 of the system of the seller 152 for accurate accounting of the received payment. In addition to a funds transfer, other means of payment, for example using a credit card or using virtual currencies such as Bitcoin or similar, are of course also conceivable.

From the time no later than the time at which the financing of a bill was transacted, all changes in the bill data and status changes of the bills, which have an impact on the assessment of the bill with regard to its risk of default, are tracked by the management platform 100. For example, a previously unconfirmed bill may have been confirmed by the buyer after transaction of the financing arrangement, or a bill may be contested by the buyer—for example due to a delivery of faulty goods. Such information is provided by updating the database 114 and the financing arrangements stored therein that are affected. In addition, if necessary the financing transactions in the database 134 are also updated and the financiers 140 affected are informed of the change via the user interface 136.

As soon as the payment target of a financed bill is reached, the buyer designated in the financed bill submits a corresponding instruction for payment of the bill amount to the platform 100 or the relevant program module 126. The program module 126 recognizes that the bill designated in the instruction is a financed bill and accordingly forwards the payment, which is actually directed to the seller, to the financier 140. In this case, a piece of payment information is attached to the payment indicating that it is the settlement of a provided financing arrangement, wherein, for example, the related financing transaction is identified. In this way, the payment received can be automatically assigned to the corresponding financing arrangement by an accounting system of the financier 140.

After the costs incurred by the financier 140 due to the financing have been paid by the buyer 136, the bill is transferred to the database 116 in which settled bills, hence both financed and non-financed bills, are managed. In addition, the corresponding financing transaction is updated and a corresponding piece of information is communicated to the financier 140 via the user interface 136. The settled bills, both financed and non-financed, stored in the data base 116 with the corresponding billing information can then be further used to prepare forecasts for the default risks of further bills from the respective buyers and/or sellers. Finally, the business performance indicators stored in the databases 142 and 148 are updated to reflect the impact of the financing provided by modified performance indicators.

In the event that a bill has not been financed by a corresponding financier 140, the instruction received by a buyer 136 for payment of a bill is further processed in the conventional way, by a payment transfer of the bill amount to the seller being issued by the buyer. In this case also, the relevant adjustments are made to the stored operating business performance indicators and to the data used for risk assessment for future bills. At the same time, a buyer 136 can add additional information to the payment instruction to the seller 138, which indicates, for example, whether and within what limit a discount is being claimed, whether a settlement will be made with previous credits, or in the event of a reduced payment to the seller 138 what the reason is for the reduction of the payment amount. This information can be read out by the management platform 100 and used for future risk assessments in other bills, among other purposes.

The invention is not restricted to any one of the embodiments described above, but may be modified in a wide variety of ways.

All of the specified features or advantages from the claims, the description and the drawing, including constructional details, spatial arrangements and method steps, can be essential to the invention either in themselves or in the most diverse combinations.

1. A computer-implemented method for automatically financing bills between a buyer and a seller by means of at least one financier using a management platform which has at least one database and at least one analysis unit, wherein flat-rate financing offers for financing bills for the at least one financier and target values for business performance indicators of at least the seller and/or the buyer are stored in the at least one database, wherein the method has the following steps:
receiving a bill from at least one of the buyer and the seller by means of a management platform, wherein the bill contains at least one piece of billing information;
ascertaining at least one potential financier for the bill by comparing the at least one piece of billing information of the bill with the flat-rate financing offers of the at least one financier and the target values for the business performance indicators of at least one of the seller and the buyer stored in the database of the management platform by means of the analysis unit;
if at least two potential financiers have been ascertained, ascertaining the best financier, whose flat-rate financing offer corresponds to the target values for the business performance indicators of at least one of the seller and the buyer, by means of the analysis unit, automatically transacting the financing of the bill by the ascertained financier using the management platform; and
transferring the bill amount from the financier to the seller; and
wherein subsequent payment from the buyer to the seller in order to settle the bill is redirected to the financier by means of the management platform in the event of a successful financing of the bill by means of a financier.

2. The method as claimed in claim 1, characterized in that the bill information has a piece of information which identifies the bill itself, the context of the bill or a history of the bill or both the context of the bill and the history of the bill.

3. The method as claimed in claim 1, characterized in that the analysis unit is designed to determine a risk value for a received bill from the bill information, wherein the risk value specifies a probability that a bill will be paid by a buyer on time.

4. The method as claimed in claim 3, characterized in that in the flat-rate financing offers of a financier an upper limit for risk values of bills is defined, wherein for bills whose risk value is above the defined upper limit the corresponding financier is not ascertained as a potential financier or the bill is referred to the financier with the second-best flat-rate financing offer, or both the corresponding financier is not ascertained as a potential financier and the bill is referred to the financier with the second-best flat-rate financing offer.

5. The method as claimed in claim 1, characterized in that in the flat-rate financing offers at least one of the following is defined: a financial limit for a financing arrangement; a number of bills to be financed; at least one of the nature and risk profile of the bills to be financed; at least one buyer to be financed; at least one seller to be financed; and at least one of a pair of buyer and seller to be financed and a minimum profit to be achieved.

6. The method as claimed in claim 1, characterized in that bills from a bill management system of at least one of a buyer and a seller are automatically sent to the management platform after issuing of the bill.

7. The method as claimed in claim 1, characterized in that before the transaction of the financing of the bill by the financier, the management platform requests a confirmation from at least one of the buyer and the seller, wherein the financing of the bill by the financier is only transacted when all of the requested confirmations are issued.

8. The method as claimed in claim 1, characterized in that a first piece of payment information is attached to the remittance of the bill amount from the financier to the seller by the management platform, wherein the first piece of payment information indicates at least that the payment is made as a result of a financing, the bill on which the payment is based, and the adjustment of the bill amount which is made due to the financing.

9. The method as claimed in claim 1, characterized in that in the event of financing of a bill by a financier, the management platform generates a financing transaction associated with the financed bill and the financier, which it stores in the database, wherein financiers have access to the respective financing transactions associated with them.

10. The method as claimed in claim 9, characterized in that when redirecting the payment from a buyer to the financier the management platform attaches a second piece of payment information, wherein the second piece of payment information identifies the financing transaction which is associated with the financed bill on which the payment is based.

11. The method as claimed in claim 1, characterized in that the remittance of the bill amount from the financier to the seller is instructed by the management platform.

12. The method as claimed in claim 1, characterized in that the financier is informed of changes in the billing information after the forwarding of the bill to the financier.

13. The method as claimed in claim 1, characterized in that the management platform stores a history of the bills processed by the management platform in the database, wherein from the history, the stored flat-rate financing offers and the stored target values for business performance indicators of at least one of the buyers and the sellers, the analysis unit determines a risk profile for bills with similar billing information for future financing arrangements and provides it to the at least one financier.

14. The method as claimed in claim 1, characterized in that the buyer can change the bill information of the bill or add additional bill information to the bill or both change the bill information of the bill and add additional bill information to the bill.

15. The method as claimed in claim 1, characterized in that at least one of the financiers is a buyer.

16. A management Platform for automatically financing bills between a buyer and a seller by means of at least one financier, wherein the management platform has at least one database and at least one analysis unit, wherein flat-rate financing offers for financing bills for the at least one financier and target values for business performance indicators of at least one of the seller and/or and the buyer are stored in the at least one database, wherein the management platform is designed:
to receive a bill from at least one of the buyer and the seller, wherein the bill contains at least one piece of billing information;
to ascertain by means of the analysis unit at least one potential financier for the bill by comparing the at least one piece of billing information of the bill with the flat-rate financing offers of the at least one financier and the target values for the business performance indicators of at least one of the seller and the buyer stored in the database of the management platform;
if at least two potential financiers have been ascertained, to ascertain by means of the analysis unit the best-financier whose flat-rate financing offer corresponds to the target values for the business performance indicators of at least one of the seller and the buyer;
to automatically transact the financing of the bill by the financier ascertained so that the bill amount will be paid to the seller by the financier; and
to redirect a subsequent payment from the buyer to the seller in order to settle the bill in the event of a successful financing of the bill by means of a financier.

17. (canceled)
